(19) United States
(12) Patent Application Publication
(10) Pub. No.: US 2019/0352091 A1
(43) Pub. Date: Nov. 21, 2019

(54) TRASH RECEPTACLE AND LID

(71) Applicant: Diane Duryea, Broadview Heights, OH (US)

(72) Inventor: Diane Duryea, Broadview Heights, OH (US)

(21) Appl. No.: 16/418,145

(22) Filed: May 21, 2019

Related U.S. Application Data
(60) Provisional application No. 62/674,128, filed on May 21, 2018.

(51) Int. Cl. B65F 1/16; B65F 1/06

(52) U.S. Cl. CPC B65F 1/1607; B65F 1/06; B65F 2250/11; B65F 2250/105; B65F 2250/114; B65F 1/1615

(57) ABSTRACT

An apparatus and device are disclosed which include a receptacle, a lid adapted to fit on the receptacle, and a bag attached to the lid. The lid and the bag are both configured to be disposable. The receptacle can be disposable or reusable. An assembly is also disclosed which includes a package and a plurality of lids, each lid having an attached bag.

### CROSS REFERENCE TO RELATED APPLICATIONS

This application claims priority to U.S. Provisional Application No. 62/674,128, filed May 21, 2019, the disclosure of which is herein incorporated by reference in its entirety.

### BACKGROUND

The present disclosure relates to an apparatus for the collection and disposal of trash, and more particularly relates to an apparatus which includes a receptacle and a lid having an attached bag for the collection of trash, wherein both the lid and bag are thrown away after the bag is sufficiently full. However, it is to be appreciated that the present disclosure is also amenable to other like applications.

In many situations, it is desirable to have a place where various articles can be thrown away as trash, or otherwise have a container where trash can be collected and disposed of later. Such situations often arise when a person is “on-the-go” and a full-size or generally stationary trash receptacle or container is not readily available. For example, people regularly find the need throw things away when using automotive transportation, such as driving or riding in a car. These items of trash may include things like tissues, straw wrappers, food wrappers & containers, receipts, papers, gum, etc. However, cars and other modes of transportation typically do not have a convenient location or container where trash can be collected. As such, trash is often undesirably tossed or placed somewhere in the car itself, such as door side pockets, cup holders, storage bins, wheel wells, and the like.

Existing trash receptacles or containers are generally not suited for use in small spaces such as a car. In addition, or alternatively, known trash collection options rely on a bag or liner that can be difficult to attach, remove, and/or handle once full of trash. As a result, a user is required to undesirably interact with a trash bag that might contain dirty, unsanitary, and/or environmentally harmful items of trash.

Thus, there is a need for apparatuses and assemblies that overcome the disadvantages discussed above.

### BRIEF DESCRIPTION

In accordance with embodiments described in the present disclosure, an apparatus for the receival, collection, and disposal of trash is described. The apparatus generally includes one or more components, such as a receptacle, a lid associated with the receptacle and adapted to fit thereon, and a bag fixed to or unitarily formed on the lid. The lid is configured to be attachable to and removable from the receptacle, and includes a surface which initially receives items of trash from a user. The trash-receiving surface of the lid is configured such that trash can pass therethrough. When the lid is attached to the receptacle, the bag is disposed within an interior region of the receptacle and will collect any items of trash passed through the lid surface by a user. The interior of the receptacle supports the bag as it fills up with trash, and the exterior of the receptacle is adapted to fit in or on any holding means located in various places that may be convenient to a user, such as a cup holder of a car. When the bag is completely full of trash or whenever otherwise desired to throw away the trash, the lid and attached bag are removed from the receptacle and both the lid and bag are thrown away with the trash. A new lid and attached bag can then be placed on the receptacle such that additional items of trash can be collected.

In accordance with one embodiment of the present disclosure, an apparatus for receiving items of trash is described. The apparatus includes a receptacle having a top portion, an interior region accessible from the top portion, and a bottom portion with an end wall. A removable lid is included and is adapted to fit on the top portion of the receptacle. The removable lid has an upper surface and a lower surface, and the upper surface is configured to permit items of trash to pass therethrough. A bag is attached to the lower surface of the lid for receiving the items of trash which have passed through the upper surface of the lid. The apparatus has a pre-use configuration in which the bag is collapsed against the lower surface of the removable lid and a ready-to-use configuration in which the removable lid is attached to the receptacle and the bag can expand within the interior region of the receptacle.

According to some aspects of the embodiment, the receptacle of the apparatus is made of a reusable material and the removable lid and bag are made of a disposable material.

In accordance with other aspects of the embodiment, the receptacle further comprises a first body portion, a second body portion smaller than the first body portion, and a recessed step portion disposed between the first body portion and the second body portion. The first body portion, second body portion, and recessed step portion can provide the receptacle with an exterior profile complementary to that of an automotive cup holder.

According to other aspects of the embodiment, one or more slits are disposed on the upper surface of the lid and are configured to permit the items of trash to pass through the upper surface.

In accordance with some aspects of the embodiment, a removable covering is further included which is attached to the lower surface of the lid and is configured to maintain the pre-use configuration in which the bag is collapsed against the lower surface of the removable lid

In accordance with other aspects of the embodiment, a means for fastening the removable lid to the receptacle is included. The fastening means has at least one of a continuous threaded arrangement or an annular snap joint.

In accordance with a second embodiment of the present disclosure, a device for receiving items of trash is described. The device includes a receptacle with a top portion open to an interior region of the receptacle and a sidewall having an exterior profile complementary to that of an automotive cup holder. A lid with an upper surface and a lower surface is also included, the lid being attachable to and removable from the receptacle. The upper surface of the lid provides access to the interior region of the receptacle. A bag is attached to the lower surface of the lid and is expandable within the interior region of the receptacle. The device also includes an assembled configuration where the lid is attached to the receptacle and the bag is disposed within the interior region of the receptacle.

According to some aspects of the second embodiment, the removable lid and bag are made of a disposable material. The disposable material includes paper, biodegradable material, Styrofoam, and plastic, for example. The receptacle is made of a reusable material. The reusable material includes plastic, plastic blends, silicon, ceramic, and metal, for example.

In accordance with other aspects of the second embodiment, the lid further comprises one or more sidewalls adapted to provide a tight transition fit or a clearance fit with the top portion of the receptacle. The one or more sidewalls can accommodate a fastening means which is adapted to permit attachment and removal of the lid to and from the top portion of the receptacle.

According to other aspects of the second embodiment, a removable covering is attached to the lower surface of the lid and is configured to conceal and keep the bag collapsed against the lower surface of the lid. The removable covering can further include a pull tab adapted to assist in removing the covering from the lower surface of the lid.

In accordance with a third embodiment of the present disclosure, an assembly is described. The assembly includes a package body adapted to house a plurality of lids. A bag is attached to a lower surface of each lid in the plurality of lids. Each lid in the plurality of lids is adapted to fit on an associated receptacle and each bag on each lid in the plurality of lids is configured to be expandable within the receptacle.

In accordance with some aspects of the third embodiment, each lid and attached bag are made of a disposable material.

In accordance with other aspects of the third embodiment, a removable covering is attached to the lower surface of each lid. The removable covering is configured to maintain the bag in a collapsed arrangement against the lower surface of each lid.

According to some aspects of the third embodiment, each lid has an upper surface including one or more slits configured to permit items of trash to pass through the upper surface and into the bag.

These and other objects and advantages will become apparent from the discussion of the distinction between the disclosure and the prior art and when considering the preferred embodiment(s) shown in the accompanying drawings.

### BRIEF DESCRIPTION OF THE DRAWINGS

Reference may now be made to the drawings, which illustrate various aspects of embodiments that the disclosure may take in physical form and in certain parts and arrangements of parts wherein:

FIG. 1 is an illustration according to one non-limiting embodiment of the present disclosure showing a front perspective view of an apparatus configured to receive, collect, and dispose of items of trash, and which generally includes a receptacle, a lid adapted to fit on the receptacle, and a bag attached to or formed on the lid;

FIG. 2 is an illustration showing a front perspective view of the lid and bag from the apparatus in FIG. 1, where the bag is shown in a ready-to-use configuration;

FIG. 3 is an illustration showing a partial cross-section view of the apparatus in FIG. 1, where the lid is in an assembled configuration with the receptacle and the bag is in the ready to use configuration within the interior region of the receptacle;

FIG. 4 is an illustration showing a bottom plan view of the lid from the apparatus in FIG. 1 and which shows a covering adapted to maintain the bag in a pre-use configuration; and

FIG. 5 is an illustration according to another non-limiting embodiment of the present disclosure showing a partial cross-section and front perspective view of an assembly including a package and a plurality of lids, each lid having a bag attached to or formed thereon.

### DETAILED DESCRIPTION

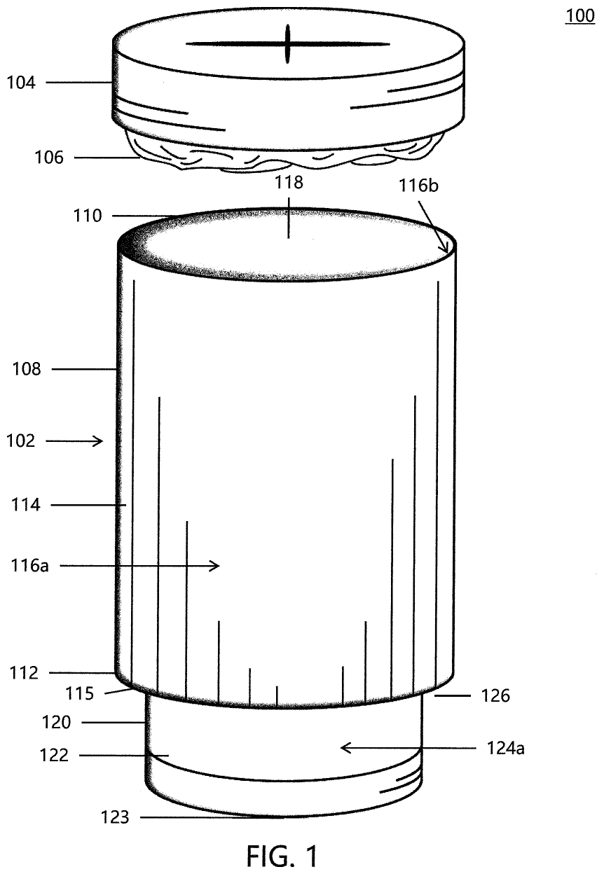

Referring now to the drawings, wherein the showings are for the purpose of illustrating non-limiting embodiments of the disclosure only and not for the purpose of limiting the same, FIGS. 1-5 illustrate various aspects of apparatuses and assemblies for the easy collection and disposal of trash in accordance with the present disclosure, as well as various aspects of the component parts that make up the apparatuses and assemblies. More particularly, FIGS. 1-5 illustrate various aspects of a receptacle and a lid configured to receive, store, and dispose items of trash from a user that is “on-the-go” or otherwise in a location or situation where a full-size or generally stationary trash receptacle is not readily available (e.g., in the car).

Referring now to FIG. 1, there is illustrated an apparatus 100 configured to receive, collect, and dispose items of trash. The apparatus 100 is illustrated as having three main components, including a receptacle 102, a lid 104, and a bag 106. The lid 104 and bag 106 are provided as a single component (i.e., the lid and bag are attached to each other or formed together in a unitary construction), however such a configuration is non-limiting. The lid 104 is attachable to and removable from the receptacle 102 and is adapted to initially receive items of trash. When the lid 104 is attached to the receptacle 102, the bag 106 is disposed within the receptacle and is ready to collect trash. The interior of the receptacle 102 is adapted to support the bag 106 as it fills up with trash, and the exterior of the receptacle is adapted to fit in various locations that may be convenient to a user, such as a cup holder of a car. Once the bag 106 is completely full of trash or it is otherwise desired to dispose of the trash, the user simply removes the lid 104 and attached bag 106 from the receptacle 102 and disposes both the lid and bag. A new lid and attached bag can then be fit onto the receptacle to permit the collection of more items of trash.

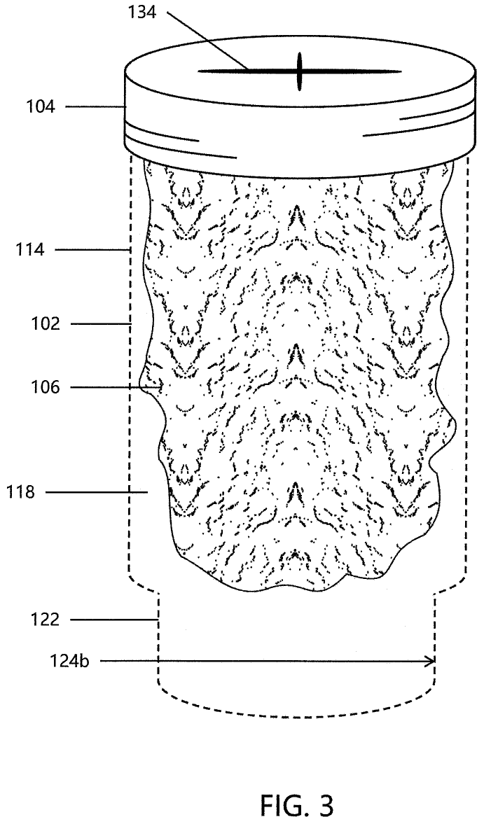

Additional features of the receptacle 102, as best seen in FIGS. 1 and 3, will now be described. In one embodiment of the present disclosure, the receptacle 102 can be composed of one or more sections of the same or different size. As illustrated in FIGS. 1 and 3, receptacle 102 has two general sections of different size, including a larger first body portion 108 and a comparatively smaller second body portion 120. However, such a configuration is non-limiting and it is contemplated that the receptacle can have any desired configuration without departing from the scope of the present disclosure. For example, the receptacle could be formed from only one body section/portion.

The first body portion 108 of receptacle 102 includes a top 110, a bottom 112, and a sidewall 114. The top 110 is generally open to an interior region 118 of the receptacle 102. In other words, the top 110 of the first body portion is not closed off by an end wall, but rather provides an opening into the interior region 118. As used herein, the term “first body portion” generally refers to the section of the receptacle which includes an open top that provides access to the interior region of the receptacle. The sidewall 114 is substantially cylindrical and/or tubular in shape and defines both an external surface 116a and an opposing internal surface 116b. Included at the bottom 112 of first body portion 108 is an end wall 115.

While the external surface 116a of the sidewall 114 of receptacle 102 is illustrated in FIG. 1 as being substantially smooth, in some embodiments the external surface can include one or more surface features (not shown) adapted to help a user grip the sidewall. The type of surface feature on the external surface is non-limiting, but might include, for example, a pattern of raised bumps or ridges, one or more indentations, or a series of grooves formed to mimic the exterior profile of a user's fingers when gripping the receptacle.

In various embodiments contemplated by the present disclosure, the end wall of the first body portion is adapted to (a) fully close off the interior region of the first body portion; or (b) transition into one or more additional body portions having differently shaped/sized interior regions. In embodiments where the receptacle is composed of only one body section, the end wall fully closes off the interior region at the bottom of the first body portion (i.e., the end wall fully defines the bottom volumetric confine of the interior region). In embodiments where the receptacle includes one or more body sections, such as the receptacle 102 illustrated in FIGS. 1 and 3, the first body portion can transition into the second body portion at or adjacent to the end wall of the first body portion. For example, the end wall of the first body portion could extend inward toward the interior region or outward therefrom to define the differently shaped and/or sized second body portion. This arrangement can be repeated for any desired number of differently shaped/sized body portions, with each body portion defining its own volumetric confine making up part of the entire receptacle volume, until a final body portion is provided with an end wall that fully closes off the interior region.

With respect to the embodiment illustrated in FIGS. 1 and 3, the end wall 115 is configured to transition the first body portion 108 into a differently shaped and/or sized second body portion 120. The end wall 115 of the first body portion is oriented substantially perpendicular to sidewall 114 and is annular in shape, with an outer diameter of the annulus being approximately equal to the diameter of sidewall 114 adjacent the bottom of the receptacle, and an inner diameter of the annulus being disposed within interior region 118. The second body portion 120 comprises a sidewall 122 which extends downward from the inner diameter of the annular shaped end wall 115. The sidewall 122 defines external and opposing internal surfaces 124a, 124b, respectively, and is substantially cylindrical. The cylindrical sidewall 122 has a diameter which is approximately equal to the inner diameter of the annular shaped end wall 115 of the first body portion 108. In other words, the sidewall 114 of first body portion 108 has a larger diameter than the sidewall 122 of second body portion 120, and the sidewalls of both body portions are concentrically aligned. As a result, a recessed step or ledge portion 126 is disposed between the first body portion 108 and the second body portion 120. The lower sidewall 122 terminates at a distal bottom or end wall 123 that is oriented substantially perpendicular to sidewall 122. End wall 123 is configured to fully close off interior region 118 (i.e., the end wall 123 defines the lower volumetric confines of the interior region 118). Accordingly, the interior region 118 is volumetrically defined by the inner surface 116b of first body portion sidewall 114, the annular end wall 115 of the first body portion 108, the inner surface 124b of second body portion sidewall 122, and the end wall 123.

The recessed step 126 discussed above may be useful, for example, when the receptacle 102 is being held in a location such as an automotive cup holder. In this regard, sidewalls 114, 122 and recessed step 126 create an exterior profile that is complementary to the profile of common cup holders, which often have one or more different diameter portions to accommodate cups, cans, receptacles, etc., of different sizes. The complementary exterior profile of the receptacle can thus provide a better fit and grip when located in a cup holder, making it less likely for the receptacle to dislodge when the vehicle is in motion. The exterior profile shape created by the sidewalls 114, 122 and recessed step 126 as illustrated herein is non-limiting, and the exterior profile of the receptacle 102 can be complementary to the profile of any desired holding means without departing from the scope of the present disclosure. For example, in some embodiments, the sidewall or sidewalls of the receptacle can taper inward from the top of the receptacle toward the bottom, such that the exterior profile of the receptacle resembles the shape of an inverted conical frustum.

Moreover, the size of the receptacle 102 is non-limiting, and the receptacle can be formed with any desired dimensions without departing from the scope of the present disclosure. However, it is generally contemplated that the size of receptacle 102, and more particularly, the volume of the interior region 118, can be similar to the size of disposable and reusable receptacles known in the art, such as cups, traveler mugs, tumblers, etc. Some non-limiting, exemplary sizes of the receptacle 102 and/or the volume of interior region 118 include from about 10 ounces to about 20 ounces, from about 20 ounces to about 30 ounces, from about 30 ounces to about 40 ounces, and from about 40 ounces to about 50 ounces or more. In this regard, the receptacle 102 is generally provided to consumers/users as being adapted to fit in various locations where a consumer/user might place existing receptacles when the consumer/user is “on-the-go”, such as a cup holder of a car or any other cup holding means.

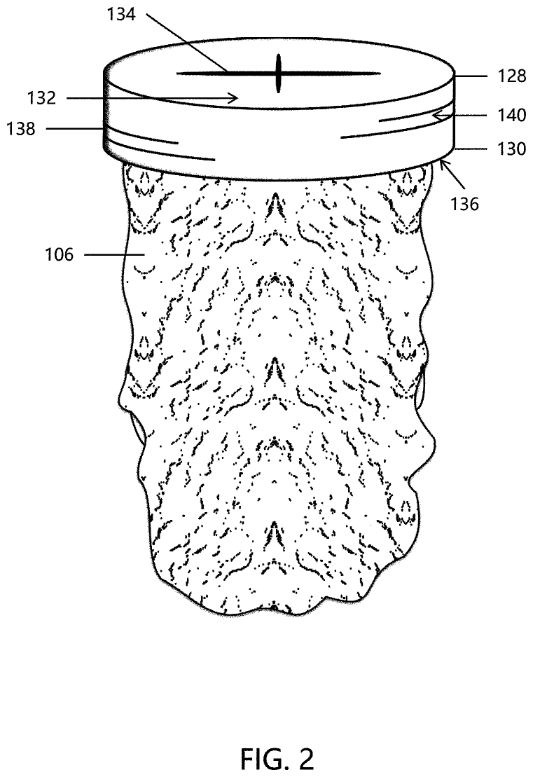

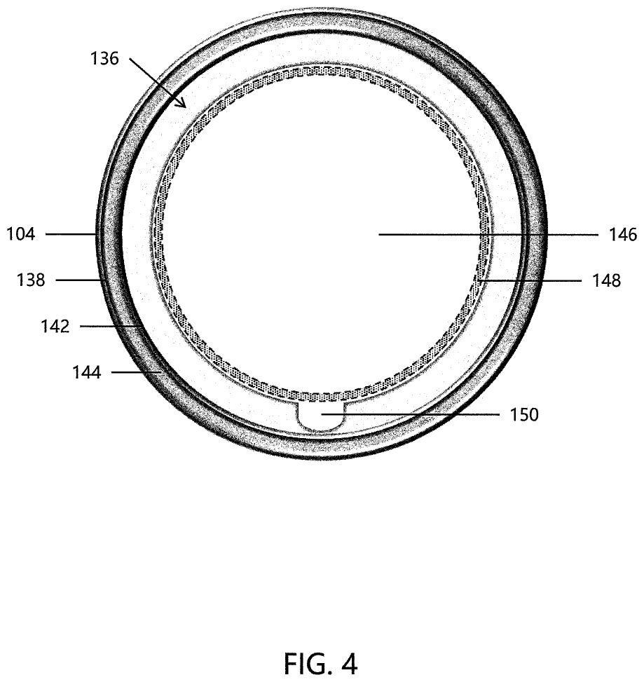

Additional features of the lid 104, as best seen in FIGS. 2 and 4, will now be described. The lid 104 includes a top 128, a bottom 130, and a sidewall 138. The top 128 of the lid 104 has an upper surface 132 which includes one or more slits 134. The one or more slits 134 allow trash items to easily pass through the upper surface 132 of the lid 104. The bottom 130 of the lid 104 has a lower surface 136 opposite to the upper surface 132. A first or outer sidewall 138 extends downward from the upper surface 132 of the lid 104 and defines a generally cylindrical exterior surface 140. However, the lid 104 can have any shape desired without departing from the scope of the present disclosure. An optional second or inner sidewall 142 can also be included. The optional inner sidewall 142 has a smaller diameter than outer sidewall 138 and is positioned on the lower surface 136 in concentric relation to the outer sidewall. As such, a channel 144 is formed between the outer and inner sidewalls 138, 142.

In some embodiments of the present disclosure in which the lid includes an outer and inner sidewall, the channel 144 can generally be sized create a tight transition fit with the top 110 of the receptacle 102. In other words, the width of the channel 144 is fractionally smaller than the thickness of the sidewall 114 at the top 110 of the receptacle 102, such that a mild force is required to attach and remove the lid 102 to/from the receptacle 104.

In other embodiments of the lid 104 where only a first sidewall 138 is included, the diameter of the first sidewall can be fractionally smaller than the diameter of the sidewall 114 at the top 110 of the receptacle 102 to create the tight transition fit between the lid and receptacle. Alternatively, the diameter of the sidewall 114 at the top 110 of the receptacle 102 can be fractionally smaller than the diameter of the first sidewall 138 to create the tight transition fit between the lid and receptacle.

In additional embodiments of the present disclosure in which the lid 104 includes outer and inner sidewalls 138, 142, the channel 144 can generally be sized to create a clearance fit with the top 110 of the receptacle 102. In other words, the width of the channel 144 is fractionally wider than the thickness of the sidewall 114 at the top 110 of the receptacle 102 to accommodate a fastening means (not shown) located on one or both external and internal surfaces 116a, 116b. The fastening means is adapted to permit the attachment and removal of the lid 104 to and from the top 110 of the receptacle 102. Additionally, the outer and inner sidewalls 138, 142 can include a fastening means (not shown) that is complementary to the fastening means located on one or both external and internal surfaces 116a, 116b of the sidewall 114.

In further embodiments where the lid 104 includes only a first sidewall 138, the diameter of the first sidewall can be fractionally larger or smaller than the diameter of the sidewall 114 at the top 110 of the receptacle 102 to create a clearance fit between the lid and receptacle. In such embodiments, either external or internal surface 116a, 116b adjacent the top 110 of the sidewall 114 can include a fastening means (not shown) adapted to permit the attachment and removal of the lid 104 to and from the top 110 of the receptacle 102. Additionally, the first sidewall 138 of the lid 104 can include a fastening means (not shown) that is complementary to the fastening means located on the sidewall 114 of the receptacle 102.

Moreover, in embodiments where the diameter of the lid's first sidewall 138 is smaller than the diameter at the top 110 of the receptacle 102 (and where the receptacle's fastening means is located on the internal surface 116b of the sidewall 114), it is contemplated that the first sidewall of the lid includes one or more body portions. For example, the lid's sidewall could include a first or upper body portion and second or lower body portion. The lower body portion of the lid has a smaller diameter than the upper body portion of the lid, and the fastening means is located on the smaller diameter portion. In such cases, when the lid and receptacle are attached via their respective fastening means, the smaller diameter lower body portion of the lid is disposed within the interior region of the receptacle and the larger diameter upper body portion of the lid is flush with the external surface of the receptacle's sidewall.

One non-limiting example of a fastening means for both the receptacle 102 and the lid 104 discussed above includes continuous threads or lugs (not shown) which permit the lid to be screwed on/off the receptacle. An additional non-limiting example of a fastening means is a friction-based arrangement where at least one element of the lid 104 (e.g., outer/inner sidewalls 138, 142 or channel 144) or a portion thereof forms a tight fit with the sidewall 114 at the top 110 of receptacle 102. In such an arrangement, opposing forces between the edge of the lid element or elements and the inside surface of the receptacle's sidewall renders enough friction to securely hold the lid at least partially within the interior region 118 and at the top of the receptacle. Moreover, a flexible seal (not shown) shaped like the lid and receptacle could also be included to increase or enhance the aforementioned frictional forces between the lid and receptacle. Another non-limiting example of a fastening means is an annular snap joint (not shown) which creates a detachable joint between the lid 104 and receptacle 102. Annular snap joints generally include a snap-fitting bead located on one of the lid or receptacle sidewalls and a groove located on the sidewall. The snap-fitting bead is adapted to fit within the groove and create a mating force between the lid and receptacle. In any event, the non-limiting fastening means should be adapted to provide an effective seal between the receptacle and lid. A gasket (not shown) can optionally be disposed within the channel 144, or be disposed on the lower surface 136 adjacent to and concentrically within the inner perimeter of the first sidewall 138, to help maintain an effective seal when the lid 104 is attached to the receptacle 102.

As best illustrated in FIG. 4, the lower surface 136 of the lid 104 also provides a surface to which the bag 106 is attached. In FIG. 4, the lid 104 and bag 106 are illustrated in a pre-use configuration. That is, the lid is not attached to the receptacle and the bag 106 is collapsed against the lower surface 136 of the lid. In the pre-use configuration, collapsed arrangement of the bag 106 is maintained by a removable covering 146 which prevents the bag from freely expanding downward and away from the bottom surface 136 of the lid (see FIG. 3). The removable covering 146 is attached to the bottom surface 136 of the lid 104 by an attachment means, such as adhesive material 148 located between the lid's bottom surface 136 and the removable covering. The adhesive material 148 is typically deposited such that an outer perimeter thereof is located within an outer perimeter of the removable covering 146. Such an arrangement ensures that the bag 106 does not stick to or otherwise interact with the adhesive 146. As illustrated in FIG. 4, the removable covering 146 is generally circular in shape and the adhesive 148 is generally annular in shape. The outer diameter of the annulus of the adhesive 148 is smaller than the diameter of the covering 146 and the annular adhesive and covering are concentrically aligned. The bag, which is not visible in FIG. 4, is concealed under the covering 146 and is located within the inner diameter of the annular adhesive material.

The removable covering 146 also includes a pull tab 150 which allows the covering to be easily grabbed by a user and assists in the action of pulling the covering away from the adhesive 148 and off the bottom surface 136 of the lid. Once the covering 136 is removed, the bag 106 can expand freely in a downward direction away from the bottom surface 136 of the lid, as illustrated in FIG. 2. In other words, once the covering 146 is removed, the lid 104 is in a ready-to-use configuration, and the lid can be attached to the receptacle 102.

With reference to FIG. 3, the receptacle 102 and lid 104 are illustrated in an assembled configuration. In the assembled configuration, the bag 106 is disposed within the interior region 118 of the receptacle 102. During use of the assembled receptacle 102 and lid 104, items of trash are pushed against the top 128 of the lid at the area of the upper surface 132 where the one or more slits 134 are located. Eventually the pushing force overcomes the resistance of the upper surface portions adjacent the slits 134 and the trash falls into the bag 106. In this regard, at least the top 128 of the lid can be made from a pliable material, such as plastic, rubber, etc., such that the portions adjacent the slits 134 in the lid's top are able to flex downward in response to any pushing force applied thereto. The slits 134 thus permit items of trash to easily pass through the upper surface 132 of the lid and into bag 106, but also advantageously prevent the items of trash from passing back through the bottom 130 of the lid and out of the bag, since external pushing forces are not typically applied to the portions adjacent the one or more slits in the lid's bottom.

As trash items begin to collect and fill the bag 106, the bag expands within the volume of the interior region 118 of the receptacle 102. Once the bag 106 is substantially full of trash and has expanded to substantially fill the volume of the interior region 118, the lid 104 and bag are both removed from the receptacle 102 and thrown away. A new lid in the pre-use configuration is then retrieved, the covering is removed from the bottom of the lid to put the bag into the ready-to-use configuration, and the lid and receptacle are attached into the assembled configuration, thereby permitting the collection of additional items of trash.

In some embodiments of the receptacle 102 described herein, the receptacle can be made from a reusable material. The reusable material used is non-limiting, however some examples include plastics such as high-density plastics and various plastic blends known in the art, silicon, ceramic, metal, etc. In other embodiments, the exemplary receptacle 102 can be made of a disposable material that is generally not suitable for extended use with an associated lid and bag. The disposable material used is non-limiting, however some examples include paper, biodegradable materials, Styrofoam, plastics, etc. However, all embodiments of the exemplary lid 104 described herein are generally made of a disposable material. In some embodiments, both the lid and receptacle can be made of the same disposable material. In other embodiments, the lid and receptacle can be made of different disposable materials.

As used herein, the term “re-usable materials” refers to materials used to make items of manufacture that are not generally thrown away or disposed of after one or a few instances of being used for a particular purpose. Put more simply, “re-usable materials” as used herein refers to materials that are adapted for multiple instances of being used for a particular purpose. Conversely, the term “disposable materials” as used herein refers to materials used to make items of manufacture that are generally thrown away or disposed of after one or a few instances of being used for a particular purpose.

The bag 106 can be made from any suitable material known in the art without departing from the scope of the present disclosure, including plastics such as low-density polyethylene (LDPE), linear low-density polyethylene (LLDPE), or high-density polyethylene (HDPE). Moreover, the bag can be provided with one or more reinforcement features (not shown) to help prevent leaks, rips, tears, etc. The bag can further be provided with one or more compositions adapted to perform as an odor neutralizer or air freshener. In addition, or alternatively, the interior region of the receptacle could also be provided with odor neutralizers or air fresheners.

The covering 146 can be made from any suitable material known in the art without departing from the scope of the present disclosure, such as plastic, cellophane, foil, silicon, etc., and the like.

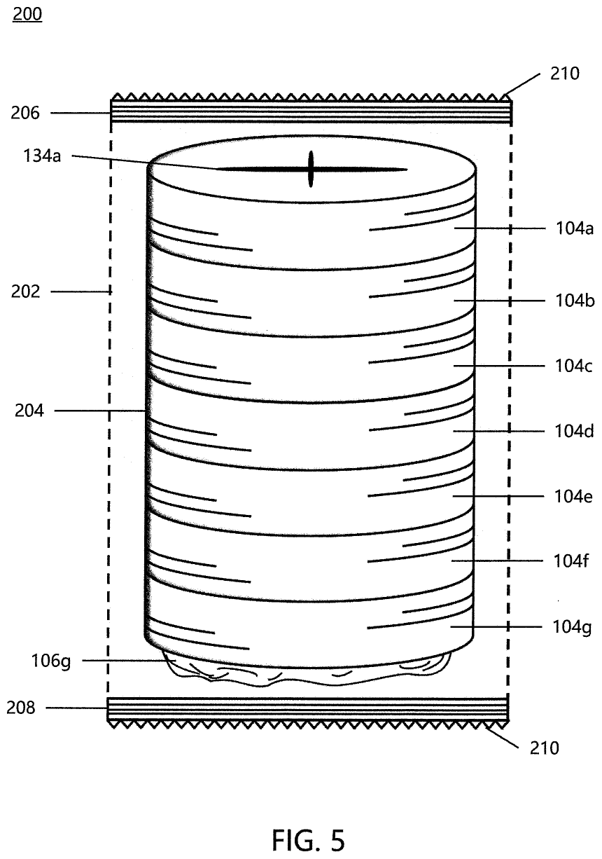

Referring now to FIG. 5, there is illustrated an assembly 200 according to another embodiment of the present disclosure. The assembly 200 includes a package body 202 adapted to house a plurality of lids 104a-104g, each lid having the features discussed above. The plurality of lids 104a-104g are stored within the package body 202 as a stack 204, however such an arrangement is only exemplary and the present disclosure is not limited thereto. The package 202 generally includes a top 206 and a bottom 208, where both the top and bottom of the package include at least one easy-tear portion 210 adapted to provide easy opening of the package. One or more slits 134a as previously described can be seen in the top lid 104a of the stack 204, and a bag 106g as previously described can be seen attached to the bottom lid 104g in the stack. Bag 106g is typically provided under a covering on the bottom lid 104g, but is shown in FIG. 5 as being partially expanded for illustration purposes only.

The stack 204 in the package 202 is an exemplary embodiment of a configuration where a plurality of lids (such as lids 104a-104g) would be provided as a point-of-sale product. More particularly, it is contemplated that the stack of lids in package 202 is sold to consumers/users as a set of “re-loadable” lids. Such lids are adapted to fit on an associated receptacle (such as receptacle 102 described above) which a consumer/user may already own. As such, a consumer/user of the receptacle/lids disclosed herein can purchase the package 202 containing a new stack 204 of lids 104a-104g once a previous stack of lids and bags has been exhausted. In addition, while the stack 204 in FIG. 5 is illustrated as having seven (7) lids 104a-104g, the number of lids provided in a package is non-limiting, and any number of lids can be provided without departing from the scope of the present disclosure.

In addition, in some embodiments of the present disclosure, it is contemplated that the exemplary lids described herein could be used without an associated receptacle (such as receptacle 102 described above). In such cases, the lid and attached bag could be held by a means specially adapted to fit in or attach to an interior component of a car. The holding means would also be specially adapted to support the lid and attached bag without the use of a receptacle.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An apparatus for receiving items of trash, comprising:
a receptacle having a top portion, an interior region accessible from the top portion, and a bottom portion with an end wall;
a removable lid adapted to fit on the top portion of the receptacle and having an upper surface and a lower surface, the upper surface being configured to permit items of trash to pass therethrough; and
a bag attached to the lower surface of the lid for receiving the items of trash which have passed through the upper surface of the lid,
wherein the apparatus includes at least one of a pre-use configuration in which the bag is collapsed against the lower surface of the removable lid or a ready-to-use configuration in which the removable lid is attached to the receptacle and the bag is expanded within the interior region of the receptacle.

2. The apparatus of claim 1, wherein the receptacle is made of a reusable material and the removable lid and bag are made of a disposable material.

3. The apparatus of claim 1, wherein the receptacle further comprises a first body portion, a second body portion smaller than the first body portion, and a recessed step portion disposed between the first body portion and the second body portion.

4. The apparatus of claim 3, wherein the first body portion, second body portion, and recessed step portion provide the receptacle with an exterior profile complementary to that of an automotive cup holder.

5. The apparatus of claim 1, further comprising one or more slits disposed on the upper surface of the lid and configured to permit the items of trash to pass through the upper surface.

6. The apparatus of claim 1, further comprising a removable covering attached to the lower surface of the lid and configured to maintain the pre-use configuration.

7. The apparatus of claim 1, further comprising a means for fastening the removable lid to the receptacle, the fastening means including at least one of a continuous threaded arrangement or an annular snap joint.

8. A device for receiving items of trash, comprising:
a receptacle with a top portion open to an interior region of the receptacle and a sidewall having an exterior profile complementary to that of an automotive cup holder;
a lid with an upper surface and a lower surface, the lid being attachable to and removable from the receptacle, the upper surface providing access to the interior region of the receptacle;
a bag attached to the lower surface of the lid and expandable within the interior region of the receptacle; and,
an assembled configuration wherein the lid is attached to the receptacle and the bag is disposed within the interior region of the receptacle.

9. The device of claim 8, wherein the removable lid and bag are made of a disposable material.

10. The device of claim 9, wherein the disposable material comprises at least one of paper, biodegradable material, Styrofoam, or plastic.

11. The device of claim 8, wherein the receptacle is made of a reusable material.

12. The device of claim 11, wherein the reusable material comprises at least one of plastic, plastic blends, silicon, ceramic, or metal.

13. The device of claim 8, wherein the lid further comprises one or more sidewalls adapted to provide a tight transition fit or a clearance fit with the top portion of the receptacle.

14. The device of claim 13, wherein the one or more sidewalls accommodate a fastening means adapted to permit attachment and removal of the lid to and from the top portion of the receptacle.

15. The device of claim 8, further comprising a removable covering attached to the lower surface of the lid and configured to conceal and keep the bag collapsed against the lower surface of the lid.

16. The device of claim 15, wherein the removable covering further comprises a pull tab adapted to assist in removing the covering from the lower surface of the lid.

17. An assembly comprising:
a package body adapted to house a plurality of lids; and,
a bag attached to a lower surface of each lid in the plurality of lids;
wherein each lid in the plurality of lids is adapted to fit on an associated receptacle and each bag on each lid in the plurality of lids is configured to be expandable within the receptacle.

18. The assembly of claim 17, wherein each lid and attached bag are made of a disposable material.

19. The assembly of claim 17, further comprising a removable covering attached to the lower surface of each lid, the removable covering configured to maintain the bag in a collapsed arrangement against the lower surface of each lid.

20. The assembly of claim 17, wherein each lid has an upper surface including one or more slits configured to permit items of trash to pass through the upper surface and into the bag.
